(19) United States
(12) Patent Application Publication
(10) Pub. No.: US 2012/0310652 A1
(43) Pub. Date: Dec. 6, 2012

(54) Adaptive Human Computer Interface (AAHCI)

(76) Inventor: Daniel O'Sullivan, Southold, NY (US)

(21) Appl. No.: 12/475,681

(22) Filed: Jun. 1, 2009

(51) Int. Cl. G10L 21/00

(52) U.S. Cl. 704/270.1; 704/E21.001

(57) ABSTRACT

An Adaptive Human-Computer Interface (AAHCI) allows an electronic system to automatically monitor and learn from normal in-use behavior exhibited by a human user via responses generated by the supported input devices and to adjust output to the supported output devices accordingly. This Auto-Learning process is different than computer-directed training sessions and takes place as the user begins to use the device for the first time and with repeated use over time. The purpose of AHCI is to provide a user experience that is tailored to the skills, preferences, deficiencies and other personal attributes of the user automatically via machine-learned processes. This in turn provides an improved user experience that is more productive and cost efficient and that can automatically optimize itself over time with repeated use.

### CROSS-REFERENCE TO RELATED APPLICATION

This application for letters patent is a continuation of provisional patents for VoiceXL for VXML and VoiceXL for Processors applications filed on Aug. 25, 2004, Multimodal VoiceXL filed on Aug. 4, 2003, VoiceXL Provisional Patent Application filed on May 20, 2003, Easytalk Provisional Patent Application filed on May 9, 2001 and U.S. Pat. No. 5,493,608.

### STATEMENT REGARDING FEDERALLY SPONSORED RESEARCH OR DEVELOPMENT

Not Applicable

### FIELD OF THE INVENTION

This invention pertains to information dissemination systems, and particularly to interactive voice response systems wherein users communicate with a computer over conventional telephone lines.

### BACKGROUND OF THE INVENTION

This invention is a modification to my U.S. Pat. No. 5,493,608 patent for a caller adaptive voice response system (CAVRS).

### BRIEF SUMMARY OF THE INVENTION

The AHCI allows an electronic system to monitor behavior exhibited by a human user via responses generated by the supported input devices and to adjust output to the supported output devices accordingly. The purpose of AHCI is to provide a user experience that is tailored to the skills, preferences, deficiencies and other personal attributes of the user automatically via machine-learned processes. This in turn provides an improved user experience that is more productive and cost efficient and that can automatically optimize itself over time with repeated use.

### DETAILED DESCRIPTION OF THE INVENTION

The AHCI implementation generally takes the form of a software program written in Java, C# or another modern programming language. The software program runs on electronic devices including Interactive Voice Response (IVR) systems and services, desktop computers and workstations, laptop and palm computers, book readers, networked computers, mobile phones including iPhone, Blackberry and other mobile devices, personal electronics such as MP3 players, wearable computers, PDA's, calculators, web servers, mainframe and supercomputers, auto and vehicle computers, embedded devices and any machine that performs data processing functions and requires human interaction.

In the context of this document, a device can refer to any of the above systems or an electronic service that provides functionality similar to that of the system. The software allows the electronic device to monitor and learn human behavior for a given user or group of users via the selections, skill and speed of their responses and to adjust the device output in such a way as to provide an improved experience for the user.

### Adaptive Technology in Telecommunications (Adaptive Audio™)

The Adaptive Audio (http://www.interactive-digital.com) software product from Interactive Digital is an implementation of adaptive technology for a telecommunications (and specifically an IVR) environment. Since the input device in this case is generally a Mobile Phone, Satellite Phone or Landline Phone using the PSTN, VoIP, Cellular or other means of communication over distance, there are particular benefits to employing this technology in this environment.

Whether Speech, Touch-Screen, a DTMF keypad or other input mechanism is used via the remote input device, the savings Adaptive Audio provides in terms of efficiency and productivity gains are compounded via the nature of the communication medium itself and the types of users (customers) it tends to serve. High volume inbound call centers using hosted and on premise IVR systems for the enterprise save with increased call automation rates, shorter call times, fewer caller errors, increased IVR utilization and improved customer service.

Traditional IVR Systems are not adaptive in nature. Even state-of-the art IVR's do not automatically sense the skill level and competency of the person using it, let alone do anything useful with that information. This leaves a lot on the table in terms of human-machine productivity, efficiency and usability.

Designers of existing IVR Systems for example, record all voice messages to be played to the caller at a single one-size-fits-all pace. The IVR then plays each message in turn as the caller navigates the IVR Application Call Script. This results in IVR calls being “out of sync” with the natural conversational pace of most callers. This in turn results in a longer, less productive telephone call. Worst still, the caller is more likely to become frustrated with the IVR and opt to speak to a live agent. Since agent answered calls cost 5-10 times more than automated calls on average, this presents both economic and resource problems for the service provider.

Some specific features of the Adaptive Audio software include:

Adjusting the audio speaking rate (words per minute) faster or slower, delivered with alternate inflection, prosody, nuance and speaking volume in accordance with detected responses from the user. A particular combination of these audio output characteristics is known as the Audio Output Profile or AOP for a given user. The AOP will likely be different for each user though users with similar demographics, age, gender, culture and socioeconomic groups may have similar AOP's. Additionally, the AOP may vary for each user during a user-device interaction and for the same user over time.

The Auto-Learning Process. When run for the first time, the software listens and learns how effectively callers navigate each of the voice applications existing response entry points (nodes). It continues monitoring these responses for several passes through each node to learn how to make intelligent decisions as to when and how to adjust the AOP for a caller of a particular skill level. After acquiring a sufficient calibration sample, the system automatically switches to adaptive mode. Here the software uses the previously stored behavioral information to automatically adjust the AOP to suit the skills and exhibited behavior of each individual caller in real-time. This process supports both context-sensitive and context independent tuning to voice applications.

Using an AOP with slower playback of voice messages at a louder decibel volume when a novice, older or hearing-impaired user is detected.

Using an AOP with alternately worded voice messages and/or alternate inflection or nuance in the played messages when, for example, an error or timeout response may cause a more encouraging, softly worded and sympathetic response. Correct and/or speedy responses would produce more affirmative possibly terse responses.

Using Login/Passwords, Voice Biometrics, Telephony ANI (Automatic Number Identification) or other means of repeat user identification and using an AOP known to work well for that user.

Using ANI, country and city codes from originating calls, speech sampling and other means to determine likely native speaking accent and/or language of the caller and provide the same accent/language via the device.

Detecting via the speech recognition engine signs of caller distress, confusion, certainty, boredom, frustration or other response and using an appropriate AOP for the user just as a human would to handle the same situation.

Use a clear, well-defined and possibly fixed rate AOP for specific voice messages in the voice interaction dialogue. This is useful for disseminating mailing addresses, bank balances and any other information the user may want to write down.

Best Modality Signaling—Informs the voice application whether Speech or DTMF input has historically been more efficient and/or more successful by a significant margin at each node in the voice application call script. Used to recommend the best input modality to use on a per node basis.

Adaptive Timeout Control—Allows the voice application to dynamically extend timeout periods for individual callers having significant difficulty navigating areas of the call script. Since Adaptive Audio is aware of when each individual caller is experiencing difficulty navigating any or all of the call script, it can inform the voice application as how much additional time (in one second intervals) should be added to an existing timeout value to allow such a caller to respond.

Preemptive Transfer Alerts—This feature keeps a cumulative index of how well each individual caller is navigating the call script and Identifies callers having excessive difficulty navigating the voice application. When callers like this are identified by Adaptive Audio, it recommends preemptively transferring them to a Customer Service Representative (CSR). Thresholds are user programmable and PTA signals factor in the likelihood that a CSR is available based on incoming call volume or other means.

Dynamic Application Smoothing—Dynamically adjusts the WPM speaking rate up or down for any points in the call script that the majority of callers find particularly easy or difficult to navigate. Adjustment decisions are based on the level of difficulty of each node as determined by the behavioral data collected by Adaptive Audio over time.

Application Dependent Profiles—Provides independent control over AOP selection criteria in multi-application environments.

Caller Behavior Analytics—Provides real time, comprehensive analysis and reporting of caller behavior, response times, error responses, caller navigation skills and willingness to use the voice application. Pinpoints application trouble spots and indicates where the application design can be improved. Also included are navigation ratings for each node in the voice application and Adaptive versus Non-Adaptive performance comparisons.

Adaptive Audio has a proven track record for improving IVR containment rates and reducing call duration. When configured for improved IVR containment, an increase of 1-5 percent of calls handled in the IVR can be expected. If shorter call durations are the goal, a 6 second savings on a 90 second script is typical. In general, the more levels of scripting and the higher the average IVR call duration, the greater the savings.

### Adaptive Audio—Key Product Benefits

Reduced Operational Expenses
Increased Productivity
Increased Customer Satisfaction
Dynamically Personalized IVR Calls
More Calls Handled in IVR
Shorter IVR Calls
Increased Peak Capacity
Very short, demonstrable ROI

See Appendix B and visit our Adaptive Audio Web Site at http://www.interactive-digital.com or obtain one of our white papers for further details on the business and technical aspects of Adaptive Audio.

### Adaptive Technology for Consumer Electronics

This technology group includes multimodal devices such as Smartphones, Apple's iPhone and iPod, MP3 Players, Personal Computers (Laptops, Desktops, Wearable Computers etc.), GPS Enabled Devices, Book Readers, Video Games and any technology requiring human interaction. What follows is an overview of these applications of our technology to the consumer electronics market.

### Adaptive Technology in Personal Electronics Devices (PED's)

This technology group includes Smartphones, Apple's iPhone and iPod, MP3 Players and any similar personal electronics device.

Audio and Video playlists, music genres and listening/viewing times during the day such as morning/evening commutes, evening relaxation, physical exercise and training schedules, study periods and so forth can be Auto-Learned and used to offer smart, personalized options for rapid selection to the user. This also offers a great marketing opportunity for music and video delivery systems like iTunes since intelligent, personalized suggestions can be offered to the user. The technology can also be optioned for automatic mode, where the user simply allows the AHCI device to provide content based on Auto-Learned behavior over time.

This AHCI implementation monitors which specific music, videos, web sites and other audio/visual content the user selects over time and how long the user dwells on such content and media streams. It then provides search choices based on this previously learned user behavior. Content that may be on one source but is similar in nature to previously selected content from a different source can be presented to the viewer for selection. The service can be optioned to alert the user (via email, text messaging, alerts etc.) when content they have shown a demonstrated interest in is available during the present or at a future time.

### Adaptive Technology in Global Positioning System (GPS) Enabled Devices (TripSaver™)

Automobiles and PED's like the iPhone with built in GPS Navigation features provide another great opportunity to leverage the use of our Adaptive Technology. In one example, AHCI can Auto-Learn the driving habits of individuals as they commute to work, drop the kids at school, do the weekly errands and so forth. AFICI software can track the GPS coordinates for trips made frequently over time and, using a service such as Google Maps, inform the driver when there is a shorter or faster alternative route available to their frequently traveled destinations. This is like finding a shortcut the driver never new existed between points they travel on a regular basis.

Besides the obvious time and money saving advantages this implementation has for the user, there are significant benefits and contributions to the current global initiative for a “greener” planet here due to fuel economy considerations. Imagine an iPhone owner simply downloading an application from Apple' App Store, installing the app so it runs in the background. Then receiving TripSaver alerts via the iPhone itself after a month or so of Auto-Learned behavior about short cuts they never knew existed on routes they take frequently.

### Adaptive Technology in Personal Computers

Adaptive Technology is a natural fit for desktop, laptop and other forms of computers with standard input devices including a mouse, keyboard and microphone, speakers and a monitor.

Some features include:

Changing visual content displayed based on the measured preferences of the user. For example, as a user navigates via pointing and clicking on desktop icons, the icons that are used most often are displayed larger and placed in more visually prominent and easily accessible area of the screen.

Providing Help Pop-Up Windows and Guidance when users with poor mouse/keyboard input navigation skills are detected. This could be a series of repetitive keyboard errors that occur over time or poor navigation skills via the pointing device. Highly targeted tutorials on how to improve the users skills in the affected areas can be offered.

Controlling screen and window transitions (fade, dissolve, brightness, etc) based on Auto-Learned behavior. If a user points and click a mouse quickly and accurately, transitions are virtually instantaneous. If the user is slow, transitions and the types of transitions used are modulated accordingly. The visual rate of change, visual content and transition is matched and co-coordinated with what the software senses as the users abilities, skills and moods so as to produce a visual output that is more in tune with the user, promoting enhanced communication.

Modulate text with larger or smaller fonts with bolding, underline, color or other text content or attributes used for emphasis based on the sensed skill of the user. Slower, less accurate users may have difficulty typing or poor eyesight (children or the handicapped and elderly population).

Allow an author's previous style and content to be tracked for later use in suggesting user-tailored templates for email and document generation. For example, when a user is writing to a particular contact, use an email template that reflects the formatting style and tone of previous email correspondence to this contact. This would include the same type of salutation (formal, informal etc). For word-processed documents and letters, also include to addresses, date, subject line etc. If used previously.

Adaptive Web Browsing: Instead of TV shows or Music and Video behavior tracking, Web sites visited and the nature of the content viewed are tracked over time and offered again when the user request something similar. This is different than simple bookmarking and cookie collection. Web sites are tracked not just on the URL, but on the content type and topics the user previously navigated to. The amount of time the user navigates within a site, the site interaction and the frequency of navigation to that site factor into the preference rating for the site to a given user. Again, a marketing opportunity exists here for web site link placements and related product offers.

After a sufficient Auto-Learn period of use, provide reports on typing and other input device navigation skills. Provide lessons and links to improve deficient skills (another marketing opportunity). Monitoring includes the monitoring of accuracy and input times of keystrokes, mouse clicks, specific input sequences and individual options, internet web sites visited, spelling and grammar inaccuracies, search topics selected and general overall user behavior.

### Adaptive Technology in Video Games

Auto-Learning the skills of users while they interact with a video game reveals a great deal about their skills, personality and gaming style. For example, with a Role Playing Game (RPG) such as the popular SOCOM war game series, a player that behaves very carefully and relies heavily on a defensive strategy will be profiled quite differently than one that is more aggressive and perhaps careless at times. There are likely to be a many different profiles that can be Auto-Learned over time as players sign in to the game and interact with the game strategy. This information can be used to personalize the gaming experience to suit the skill of the user. It can also give the gamer very detailed and individualized feedback and offer personalized lessons on how to improve their gaming skills, something most teenage gamers would like to achieve.

The same can be done for auto racing, flight simulator, air combat and other driving oriented games as the user maneuvers their vehicle through turns, on straight paths, deal with course obstacles and the like. Chess playing, checkers, crossword puzzles and essentially electronic game can benefit from the AHCI process in the same way.

### Adaptive Technology in Time Measurement and Personal Alarms

Adaptive Technology in a timing device such as an alarm clock, wristwatch or Personal Electronics Device (iPhone, Blackberry etc.) can help promote good sleep habits for users.

The user initially sets up a profile based on their age, gender, established sleep patterns, estimated sleep requirements and willingness to improve their sleep. A keypad interface allows the user to indicate the time sleep was attempted, waking time, tracking users naps, weekend sleep schedule, mid-sleep wake-ups and other exceptions. Notifications are transmitted via audible sound, email, pager alert, telephone call or other means to communicate with a user.

If for example, a device like the iPhone is used as a personal alarm clock, waking times are automatically available to the software. This could be implemented as an iPhone application. GPS location information allows the AHCI process here to automatically account for different time zones and travel patterns of the user.

Adaptive Technology in Television Sets

A television supporting AHCI automatically monitors the viewing habits of users over time and alters content selection options accordingly. The AHCI monitors which specific channels, TV shows and audio/visual content the user selects over time and how long the user dwells on such content and channels. It then provides easy to use personalized search choices via the TV remote or on-screen instructions based on this Auto-Learned user behavior.

Content that may be on one channel but is similar in nature to previously selected content on a different channel can be presented to the viewer for selection. So a user that has had a demonstrated interest in for example, a particular baseball team, a type of sitcom or a particular news topic, would be automatically offered a direct option to view these and follow up shows on the same topic. Users in a household can uniquely identify themselves for the service so independent preference profiles can be used to tailor rapid content selection and notification for all users.

The service can be optioned to alert the user (via email, text messaging etc.) at those times when the TV is not in use as to when content they have shown a demonstrated interest in is available during the present or at a or future time. This also provides a great marketing opportunity for content providers while treating the user with personalized options they are likely to be interested in. The technology can also be optioned for automatic mode, where the user simply allows the AHCI device to provide content based on Auto-Learned behavior over time.

The adaptive technology here can be implemented in the television, the television remote control unit or as an option from the broadcast delivery service. Media transmission can be broadcast via cable, satellite, internet and other broadcast systems.

### Adaptive Technology in AM/FM/Satellite Radios

The principles for the implementation of Adaptive Technology for Radio Broadcast Services are very similar to those described earlier for the television set and personal electronics device implementations.

Music genres and listening times during the day such as morning/evening commutes, evening relaxation, physical exercise and training schedules, study periods and so forth can be Auto-Learned and used to offer smart, personalized options to users when listening to the radio on a regular basis. Content that may be on one radio channel but is similar in nature to previously selected content from a different channel can be presented to the viewer for easy selection.

This also offers a great marketing opportunity for artists, music publishers and broadcast services. The service can be optioned to alert the user when content they have shown a demonstrated interest in is available during the present or at a future time.

The various features of novelty which characterize the invention are pointed out with particularity in the claims annexed to and forming a part of the disclosure. For a better understanding of the invention, its operating advantages, and specific object attained by its use, reference should be had to the drawing and descriptive matter in which there are illustrated and described preferred embodiments of the invention.

The invention is not limited by the embodiments described above which are presented as examples only but can be modified in various ways within the scope of protection defined by the appended patent claims.

I claim:

1. An Adaptive Human-Computer Interface that allows an electronic system to monitor behavior exhibited by a human user via responses generated by the supported input devices and to adjust output to the supported output devices accordingly.

2. An Adaptive Human-Computer Interface as recited in claim 1 wherein said interface provides a user experience that is tailored to the skills, preferences, deficiencies and other personal attributes of the user automatically via machine-learned processes.
